(19) United States
(12) Patent Application Publication
(10) Pub. No.: US 2021/0078257 A1
(43) Pub. Date: Mar. 18, 2021

(54) SYSTEM AND METHOD FOR ADDITIVE MANUFACTURING

(71) Applicant: TRIEX, LLC, BARRE, VT (US)

(72) Inventor: TYLER MCNANEY, JERICHO, VT (US)

(73) Assignee: TRIEX, LLC, BARRE, VT (US)

(21) Appl. No.: 17/024,794

(22) Filed: Sep. 18, 2020

Related U.S. Application Data
(60) Provisional application No. 62/901,851, filed on Sep. 18, 2019.

(51) Int. Cl. B29C 64/295; B29C 64/118; B29C 64/209; B29C 64/321; B33Y 10/00; B33Y 30/00

(52) U.S. Cl. CPC B29C 64/295; B29C 64/118; B33Y 30/00; B29C 64/321; B33Y 10/00; B29C 64/209

(57) ABSTRACT

A system for additive manufacturing includes an extrusion apparatus configured to receive a raw material and output a flowable extrudate, a heated conduit fluidly connected to the extrusion apparatus and configured to receive the flowable extrudate therefrom, and a print head fluidly connected to the heated conduit for receiving the flowable extrudate from the heated conduit. The print head is configured to move along a path according to a preprogrammed set of instructions to produce an article from the flowable extrudate.

### CROSS-REFERENCE TO RELATED APPLICATIONS

This application claims the benefit of U.S. Provisional Application Ser. No. 62/901,851, filed on Sep. 18, 2019, which is hereby incorporated by reference herein in its entirety.

### FIELD OF THE INVENTION

The present invention relates generally to additive manufacturing, and more particularly to a material handling and deposition system for forming a three-dimensional object by additive manufacturing.

### BACKGROUND OF THE INVENTION

Additive manufacturing is a process of creating three-dimensional parts and structures by depositing overlapping layers of material under the guided control of a computer. One common form of additive manufacturing is known as fused deposition modeling (FDM), also referred to as fused filament fabrication (FFF). Using FDM, a thermoplastic filament is passed through and liquified within a heated printer extruder head mounted on a CNC or other movement system. The printer extruder head is moved in a predefined trajectory (i.e., a tool path) under computer control as the material discharges from the printer extruder head, such that the material is laid down in a particular pattern and shape of overlapping layers. Typically, the head moves in two dimensions to deposit one horizontal plane, or layer, at a time, and the work or head is moved vertically by a small amount to begin a new layer. The material, after exiting the printer extruder head, cools and hardens into a final form.

Another form of additive manufacturing is fused particle fabrication (FPF), also referred to as fused granular fabrication (FGF). FPF is similar to FDM, but uses thermoplastic pellets, particles or granular shavings rather than a filament as the raw material. FPF systems address some of the shortcomings of FDM systems, namely, that filaments are not particularly well suited to large-format printing because the amount of force that can be applied to the filament is limited (leading to a very time consuming print process for large-scale parts). FPF is capable of achieving much higher material outputs than FDM and is, therefore, a better match for large format printing. Moreover, the FPF systems allow for a wider range of materials to be 3D printed, as they can typically process plastics, including recycled plastics, that cannot be easily converted into filaments.

While FPF additive manufacturing systems have proven to be advantageous for many applications, there is room for improvement in terms of flexibility and useability. For example, with FPF systems, 3D printing can only be carried out at steep extruder head/nozzle angles (e.g., greater than 45 degrees with respect to a horizontal printing surface) due to the angle of repose of the granular raw material. Without such a steep nozzle angle, material flow (e.g., solid pellets, particles or shavings) to the head may be interrupted. In addition, with both FDM and FPF systems, the head is large, heavy and cumbersome, making it difficult to change direction quickly and easily. Scaling also requires changing out the entire extruder head, which is tedious and time consuming.

In view of the above, there is a need for an additive manufacturing system that overcomes some of the limitations of existing systems.

### SUMMARY OF THE INVENTION

In view of the foregoing, it is an object of the present invention to provide an additive manufacturing system.

It is an object of the present invention to provide an additive manufacturing system that utilizes pellets, particles and/or granular shavings as the raw material.

It is an object of the present invention to provide an additive manufacturing system that is capable of printing in almost any orientation, including at nozzle orientations of less than 45 degrees with respect to a horizontal plane.

It is an object of the present invention to provide an additive manufacturing system having a head that is much smaller and lighter than existing systems.

It is an object of the present invention to provide an additive manufacturing system that provides for an increased level of flow control.

These and other objects are achieved by the present invention.

According to an embodiment of the present invention, a system for additive manufacturing includes an extrusion apparatus configured to receive a raw material and output a flowable extrudate, a heated conduit fluidly connected to the extrusion apparatus and configured to receive the flowable extrudate therefrom, and a print head fluidly connected to the heated conduit for receiving the flowable extrudate from the heated conduit. The print head is configured to move along a path according to a preprogrammed set of instructions to produce an article from the flowable extrudate.

According to another embodiment of the present invention, a method of manufacturing an article is provided. The method includes extruding a raw material to produce a flowable extrudate at a first temperature, passing the flowable extrudate through a heated conduit to a print head, the heated conduit maintaining a flowable state of the flowable extrudate, and at the print head, passing the flowable extrudate out of a nozzle to form the article.

According to yet another embodiment of the present invention, a system for additive manufacturing is provided. The system includes an extruder configured to receive a raw material and to output a flowable extrudate at a first temperature, a heated conduit fluidly connected to the extrusion apparatus and configured to receive the flowable extrudate from the extrusion apparatus and to heat the flowable extrudate to a second temperature, and a print head fluidly connected to the heated conduit for receiving the flowable extrudate from the heated conduit. The second temperature is approximately equal to or higher than the first temperature.

### BRIEF DESCRIPTION OF THE DRAWINGS

The present invention will be better understood from reading the following description of non-limiting embodiments, with reference to the attached drawings, wherein below:

FIG. 1 is schematic illustration of an additive manufacturing system according to an embodiment of the present invention.

FIG. 2 is an enlarged view of the print head of the additive manufacturing system of FIG. 1.

### DETAILED DESCRIPTION OF THE PREFERRED EMBODIMENTS

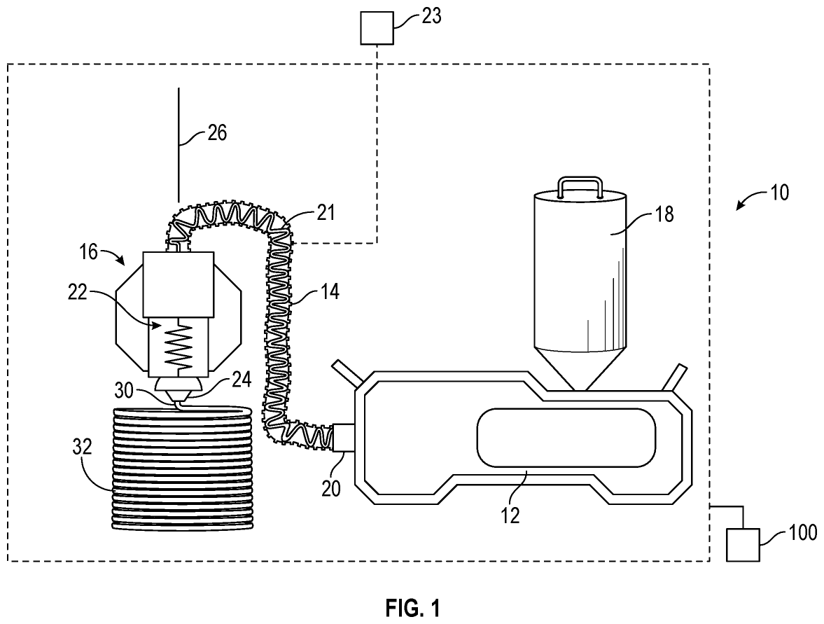

Referring now to FIG. 1, an additive manufacturing system 10 according to an embodiment of the present invention is illustrated. As shown therein, the system 10 includes an extrusion apparatus 12, a heated conduit 14 fluidly connected to an outlet of the extrusion apparatus 12, and a print head 16 fluidly connected to an opposing end of the heated conduit 14 opposite the extrusion apparatus 12. The extrusion apparatus 12 may take the form of any extrusion apparatus 12 known in the art and which is capable of accepting a raw material, heating it, and extruding it through a die or outlet. For example, the extrusion apparatus 12 may be the EX2 filament extruder or EX6 filament extruder sold by Filabot. As shown in FIG. 1, the extrusion apparatus 12 includes a feed inlet or hopper 14 configured to accept a raw material for extrusion, and an outlet 20 configured to allow for egress of melted extrudate. In an embodiment, the raw material may be in the form of pellets, granules, shavings, flakes and/or powder. In an embodiment, the raw material may be, for example, thermoplastics such as polyethylene (PE), polypropylene, acetal, acrylic, nylon (polyamides), polystyrene, polylactic acid (PLA), acrylonitrile butadiene styrene (ABS) and/or polycarbonate as the raw material, although other materials known in the art may also be utilized without departing from the broader aspects of the invention. In one embodiment, the extrusion apparatus 12 uses plastic pellets or granular shavings (e.g., recycled plastic pellets or granular shavings) as a raw material, as discussed hereinafter. The extrusion apparatus 12 may, in an embodiment, have an operating range between about 500 psi and 10,000 psi, and a length/diameter (L/D) ratio of about 24:1 or larger.

As indicated above, the heated conduit 14 is fluidly connected to the outlet 20 of the extrusion apparatus 12 and receives the melted extrudate therefrom. The heated conduit 14 includes a controllable heating element 21 that allows for precise control of the temperature within the conduit 14. In an embodiment, the heating element 21 may be a resistive heating element that substantially encircles/surrounds the interior passage of the conduit, although other types and configurations of heating elements may also be used, so long as the heating element is operable to heat the interior passage of the conduit 14 and/or the interior wall of the conduit 14, for the purpose disclosed hereinafter. In an embodiment, the heated conduit 14 may include a dedicated controller 23 for controlling the temperature of the heating element 21 (and thus the passage within the conduit 14). In other embodiments, the heating element 21 may be controlled by a master system controller 100, disclosed below. In an embodiment, the heated conduit 14 is flexible so as to allow for routing and positioning of the conduit in a variety of orientations and paths.

Importantly, the heated conduit 14 allows for the extrudate to be maintained in a flowable state (i.e. non-solid state) from the outlet 20 of the extrusion apparatus to the print head 16, as discussed hereinafter. As used herein, “flowable” or “flowable state” means that the extrudate or material is at a temperature around the glass transition temperature of the material so that the material is in a non-solidified state. This is the point when the material is moving from solid to a liquid. In an embodiment, the temperature may be between about 35% higher or lower than the glass transition temperature and, more preferably about 10% higher or lower than the glass transition temperature. In an embodiment, the material is heated to and/or maintained at a temperature above the glass transition temperature of the material by the heated conduit 14. In an embodiment, the heated conduit 14 may have an inside diameter in the range of about ⅛″ to about 4″, and more preferably about ⅛″ to about ¼″, although other sizes are possible depending on the size of the extrusion apparatus and desired material output.

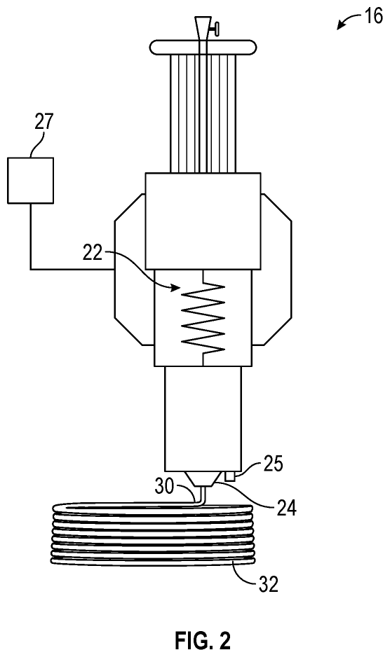

With reference to FIGS. 1 and 2, the print head 16 is fluidly connected to an opposite end of the heated conduit 14 and receives the melted/flowable extrudate therefrom. In an embodiment, the print head 16 includes a controllable heating element 22 and a nozzle 24. The heating element 22 is configured to further heat the extrudate material received from the heated conduit 14 to a molten or fluid state, while the nozzle 24 is configured to controllably dispense the molten print material 30 for deposition and formation into an article 32. The nozzle 24 preferably includes a valve system for controlling material flow out of the nozzle (in dependence upon a particular part or article being printed). The nozzle 24 may include a mechanism such as, for example, a mechanical iris that can be selectively controlled to vary a dimeter of the nozzle opening and thus the diameter or the size of material being deposited. In an embodiment, the nozzle 24 may be selectively removable from the print head 16 so that nozzles having a variety of shapes and or sizes (e.g., square, oval, etc.) can be installed.

The print head 16 may also include a cooling nozzle 25 adjacent to nozzle 24. In an embodiment, the cooling nozzle 25 may be in the shape of an annulus surrounding the nozzle 24. The cooling nozzle is configured for connection to a supply of cooling air and is controllable to direct cooling air onto the article being printed to cool the print material 30 as it is deposited to form the article 32.

The print head 16 is preferably integrated with, or connected to a control and positioning system 27 for controlling a position of the print head and nozzle thereof with respect to a substrate. In an embodiment, the control and positioning system may be a robotic arm or a CNC control system, although other control and positioning means known in the art may also be utilized without departing from the broader aspects of the invention. In an embodiment, the control and positioning system allows for movement of the nozzle 24 in any direction, and for 360 degree rotation about axis 26. In addition, the nozzle 24 can be tilted at any angle with respect to a vertical axis (e.g., the axis 26), from 0 degrees to 90 degrees. That is, the nozzle 24 and head 16 can be tilted so as to print at an angle less than 45 degrees from horizontal. In yet other embodiments, the print heat 16 may be tilted at even greater angles to allow for printing at any angle between about 0 degrees and about 180 degrees with respect to axis 26 (i.e., even upside down, with the nozzle pointing upwards).

In an embodiment, the extrusion apparatus 12, heated conduit 14 and print head 16 (as well as the movement system connected to the print head) are communicatively coupled to a centralized control unit 100. It is contemplated however, that in some embodiments, one or more of the extrusion apparatus 12, heated conduit 14 and print head 16 may have dedicated controllers for controlling operation of the respective devices (and which themselves may be communicatively coupled to a centralized controller). The control unit 100 is configured to control operation of the extrusion apparatus 12, such as controlling the temperature and extrusion rate thereof. The control unit 100 may also be configured to control a temperature of the heating element 21 of the heated conduit 14 so as to control the temperature of the extrudate material therein. Further, the control unit 100 is configured to control the position and orientation of the nozzle 24 (via control of the print head 16), as well as the heating element 22 so as to control the temperature of the material as it reaches the nozzle 24.

In operation, a raw material such as recycled plastic pellets or granular shavings are loaded into the hopper 18 of the extrusion apparatus 12. The extrusion apparatus 12, under control of the control unit 100, heats the pellets and pushes the melted pellets through a die to produce an extrudate at a first temperature. The flowable extrudate is then passed through the heated conduit 14 to the print head 16. In an embodiment, the heated conduit 14 and the extrusion apparatus 12 are operated at approximately the same temperature, to maintain the material at about the same temperature from the outlet 20 of the extrusion apparatus 12 to the print head 16. In an embodiment, the extrusion apparatus is configured to output the flowable material at a first temperature, and the heated conduit is configured to maintain the flowable material at approximately the first temperature (e.g., about 0% to about 35%, and more preferably about 0% to about 15%, and even more preferably 0% to about 5% higher or lower than the first temperature of the flowable material exiting the extrusion apparatus).

At the print head 16, the heating element 22 of the print head 16 heats the extrudate to a second temperature that is higher than the temperature within the heated conduit 14 (i.e., to the final melt temperature for printing). The print head 16 then controllably moves under control of the control and positioning system operating according to a preprogrammed set of instructions to fabricate a desired article or structure. In particular, the control and positioning system is programmed with a set of instructions to control the deposit of material from the nozzle. Additional information relating to speeds, temperatures, stop/start, flow, and other properties may be input with the programming. The program is executed, inducing motion and extrusion to create any desired structure or article.

In an embodiment, after a printing run, the print head 16 may be controllably moved to a purge table, and a purge material may be loaded into the hopper 18 of the extrusion apparatus 12. The purge material is run through the extrusion apparatus 12, heated conduit 14 and print head 16 to clean out all of the media from the prior run. It is preferred that the purge material is a flexible purge material.

Importantly, by separating the extruder from the print head, the print head can be made much smaller and lighter in comparison to existing print heads having an integrated extruder (approximately ¼ of the weight of existing heads). This reduced size and weight allows for more precise control over the position of the print head 16, allowing for motion control motors, etc., to be downsized, and resulting in the ability to produce more precise parts. In addition, the smaller size of the head 16 allows access to tighter spaces, such as when using dual print heads to simultaneously print a support substrate in combination with an article.

Moreover, by decoupling the extrusion apparatus and the print head, the extrusion apparatus can be sized as desired, and is easily swappable. That is, the same print head and nozzle, and heated conduit, may be utilized when scaling; all that is required is to remove one extrusion apparatus on the front end and replace it with another. This is in contrast to existing systems where the entire extruder head must be swapped out if scaling is desired.

Supplying the print head with a flowable extrudate (in contrast to solid pellets, granules or a filament) also provides for better useability. In particular, because the angle of repose of particulate material is no longer a concern, the head 16 and nozzle 24 can be reliably operated at almost any orientation, including horizontal (and even below horizontal). This allows for more reliable printing of contours, which has heretofore been difficult to effectively accomplish with existing systems. Working with a flowable extrudate at the head also allows for improved feeding and improved control, which results in faster printing speeds.

As alluded to above, the present invention contemplates a number of ways of achieving flow control. In one embodiment, flow control may be achieved by using the same nozzle, and by varying the extrusion rate. Alternatively, or in addition, the nozzle size may be selectively controlled (e.g., through use of a mechanical iris).

While it has been disclosed above that the print head 16 includes a heating element 22 for further heating the flowable extrudate to a molten state for printing via the nozzle 24, it is contemplated that in some embodiments, the heating element 22 may be omitted entirely. In such embodiments, the heated conduit 14 may be utilized to heat the flowable extrudate to a temperature and state needed for printing (i.e., to a temperature higher than the temperature leaving the extruder and/or to a molten or fluid state). This would decrease the size, weight and complexity of the print head even further. In such embodiments, the temperature and state of the flowable extrudate may be precisely controlled via control over the heating element 21 of the heated conduit 14.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

What is claimed is:

1. A system for additive manufacturing, comprising:
an extrusion apparatus configured to receive a raw material and to output a flowable extrudate at a first temperature;
a heated conduit fluidly connected to the extrusion apparatus and configured to receive the flowable extrudate from the extrusion apparatus and to maintain the flowable extrudate in a flowable state; and
a print head fluidly connected to the heated conduit for receiving the flowable extrudate from the heated conduit.

2. The system of claim 1, wherein:
the heated conduit includes a first heating element for heating the flowable extrudate to a second temperature; and
the print heat includes a second heating element for heating the flowable extrudate to a third temperature;
wherein the third temperature is higher than the second temperature.

3. The system of claim 2, wherein:
the first temperature and the second temperature are approximately equal.

4. The system of claim 1, further comprising:
a control and positioning system configured to move the print head along a path according to a preprogrammed set of instructions to produce an article from the flowable extrudate.

5. The system of claim 1, wherein:
the heated conduit is a flexible conduit.

6. The system of claim 1, wherein:
the raw material is in the form of at least one of pellets, granules, shavings, flakes and/or powder.

7. The system of claim 6, wherein:
the raw material is at least one of polyethylene (PE), polypropylene, acetal, acrylic, nylon (polyamides), polystyrene, polyvinyl chloride (PVC), acrylonitrile butadiene styrene (ABS) and/or polycarbonate.

8. The system of claim 1, wherein:
the print head includes a nozzle for outputting the flowable material; and
wherein the print head is rotatable 360 degrees about an axis extending through the nozzle.

9. The system of claim 1, wherein:
the print head is tiltable and operable at an angle of less than 45 degrees with respect to a horizontal surface. with respect to a horizontal axis.

10. The system of claim 8, wherein:
the nozzle is removable from the print head.

11. A method of manufacturing an article, comprising the steps of:
extruding a raw material to produce a flowable extrudate at a first temperature;
passing the flowable extrudate through a heated conduit to a print head, the heated conduit maintaining a flowable state of the flowable extrudate; and
at the print head, passing the flowable extrudate out of a nozzle to form the article.

12. The method of claim 11, wherein:
maintaining the flowable state of the flowable extrudate includes maintaining the flowable extrudate at a second temperature.

13. The method according to claim 12, wherein:
the second temperature is approximately equivalent to the first temperature.

14. The method according to claim 12, wherein:
the second temperature is higher than the first temperature.

15. The method according to claim 11, further comprising the steps of:
moving the print head to a purge area;
extruding a purge material to produce an extruded purge material;
passing the extruded purge material through the heated conduit and print head to clean out any residual flowable extrudate from the heated conduit and print head.

16. The method according to claim 11, wherein:
extruding the raw material is carried out with a first extruder; and
wherein the method further includes decoupling the first extruder from the heated conduit, and fluidly connecting a second extruder to the heated conduit.

17. The method according to claim 11, further comprising the step of:
orienting a nozzle of the print head at an angle of less than 45 degrees from a horizontal surface to form a portion of the article.

18. A system for additive manufacturing, comprising:
an extruder configured to receive a raw material and to output a flowable extrudate at a first temperature;
a heated conduit fluidly connected to the extrusion apparatus and configured to receive the flowable extrudate from the extrusion apparatus and to heat the flowable extrudate to a second temperature; and
a print head fluidly connected to the heated conduit for receiving the flowable extrudate from the heated conduit;
wherein the second temperature is approximately equal to or higher than the first temperature.

19. The system of claim 18, wherein:
the print heat includes a heating element for heating the flowable extrudate to a third temperature;
wherein the third temperature is higher than the second temperature.

20. The system of claim 18, further comprising:
a control and positioning system configured to move the print head along a path according to a preprogrammed set of instructions to produce an article from the flowable extrudate.
